(19) United States
(12) Patent Application Publication
(10) Pub. No.: US 2005/0169169 A1
(43) Pub. Date: Aug. 4, 2005

(54) Determination of an endpoint association from a transport address

(76) Inventor: Srinivas Gadde, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/769,193

(22) Filed: Jan. 30, 2004

(51) Int. Cl. H04L 12/26

(52) U.S. Cl. 370/229

(57) ABSTRACT

A received datagram is associated with the connection endpoint using a transport address index and an endpoint association array which includes a list of active transport addresses for each active endpoint association. At least some of the active endpoint lists include more than one transport address and each entry in the transport address index includes (or is linked to) one or more pointers to the specific transport addresses in the endpoint association array lists that are associated with that entry.

### BACKGROUND

The present invention is generally related to the processing of multiple streams of received datagrams, and more specifically related to the association of each received datagram with a respective process endpoint.

Sharing of information between networked computers is typically handled in a layered fashion, with each layer responsible for a different aspect of the information transfer and providing a foundation for more application specific tasks performed by higher levels. Between the various network-oriented hardware which forms the lowermost physical network layer and the various application-oriented software which forms the application layer there is typically provided a network communication layer (the IP protocol in the specific case of the Internet and internet-compatible networks), which provides a means of identifying network nodes and routing a datagram from a particular source node to a particular destination node. The actual contents of the datagram typically includes data that is associated not just to a particular node, but also to a particular process or endpoint associated with that node. Thus, the Network layer is typically followed by a Transport layer which defines an end to end connection between a particular process (or “source endpoint”) at the source node and a corresponding process (or “destination endpoint”) at the destination node.

In the case of the Internet, a Transport layer can utilize several different protocols, the best known of which is the Transmission Control Protocol (or simply “TCP”). TCP provides not only a means of associating individual processes at a particular node into respective “ports”, but also a means of reliably transporting a stream of information packets (“datagrams”) over an underlying Internet Protocol (or simply “IP”) layer from a source endpoint to a destination endpoint, with each TCP/IP logical “connection” being defined by a pair of source and destination transport addresses each consisting of an associated IP address and port number.

Stream Control Transmission Protocol (or “SCTP”) is a more advanced transmission protocol which is capable of transmitting multiple related streams between a source port at the transmitting node and a destination port at the receiving node preferably using multiple IP addresses at one or both nodes to thereby define a single logical SCTP “association”. SCTP's provision for multiple related streams between same two logical endpoints facilitates adaptive bandwidth and error correction for real-time information having components with differing priorities, while its provision for multiple IP addresses facilitates routing changes during transmission due to congestion or hardware malfunctions at the source or the destination. All transport addresses at the same end of an SCTP association must use the same port number, but can use different IP addresses. A transport address at either end of an active SCTP association must not be used by another active SCTP association. Thus, although each active SCTP association may be associated with multiple transport address pairs, all the transport address pairs of the same active SCTP association are uniquely associated with only one local SCTP endpoint.

The use of port numbers in the TCP and SCTP protocols to distinguish between logically independent streams of information that may be concurrently originating from a common source node and/or destined to a common destination node greatly enhances the utility of the network without adding substantially to the overhead information being transported between the two nodes. In practice, a unique port number assignment is typically not permanently established for each instance of each process, but rather a given port number will typically be associated with different processes (or different instances of the same process) at different times (or even with more than one concurrent connection, in the case of TCP). Thus there is no simple correlation between the source and destination Transport Addresses contained in the datagram header, and the local process or endpoint for which the received datagram is intended. In particular, in the case of TCP, the same destination Transport Address can be associated with more than one destination endpoint, while in the case of SCTP, the same destination endpoint can be associated with more than one destination Transport Address. Moreover, there is a possibility of “bogus” datagrams being received at the same local port as a genuine datagram, but from a different source.

### SUMMARY

A received datagram is associated with a local endpoint using a transport address index and an endpoint association array which includes a list of active transport addresses for each active endpoint association. At least some of the active endpoint lists include more than one transport address pair and each entry in the transport address index includes (or is linked to) one or more pointers to the specific transport addresses in the endpoint association array lists that are associated with that entry.

In one disclosed embodiment, the transport address index is accessed using a hash code derived from a transport address pair including source and destination IP addresses and source and destination port numbers, and in the event of a “colliding” hash key representing more than one active transport address pair, the index entry points to all active transport address pairs that could be represented by that hash key.

In another embodiment, a cache mechanism is included for more efficient processing of recently encountered transport addresses, possibly including not only transport address pairs associated with active local endpoints, but also those previously determined to be bogus.

### BRIEF DESCRIPTION OF THE DRAWINGS

FIG. 1 depicts multiple datagram routings between two nodes in a conventional network.

FIG. 2 depicts a logical organization of one embodiment of an association system that includes a hash key index connected by pointers to various linked lists of colliding associations and of transport address pairs.

FIG. 3 depicts a logical organization of an embodiment of an association system that includes a multiple stage hash key index for the transport pair addresses in which the linked association lists are organized as a separately indexed array.

FIG. 4 depicts one embodiment of an association process that includes indexing, matching and caching operations.

### DETAILED DESCRIPTION

It should be understood that the intended audience for this specification will be familiar with conventional technology for transmitting and receiving digital information over the Internet (or other communications networks) and with the various standards and protocols that are commonly used for such transmissions such as “TCP” and “IP”, and will be familiar with the technical jargon commonly used by those skilled in the art to describe such technology. Accordingly, unless otherwise clear from the context, it should be assumed that the words and phrases in this description and in the appended claims are used in their technical sense as they would be understood by those skilled in the art.

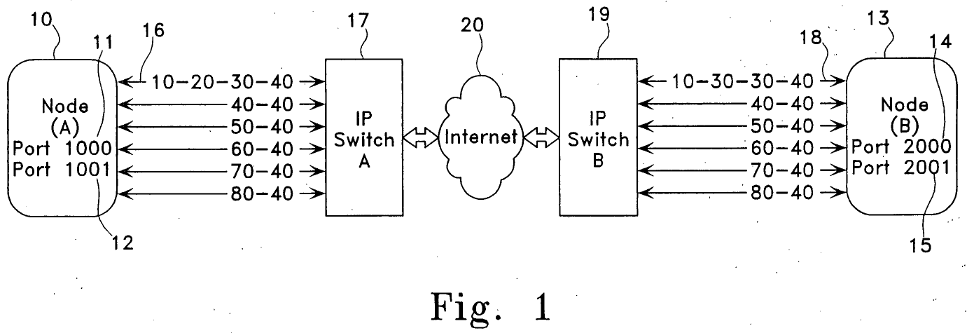

Reference should now be made to FIG. 1, which shows an exemplary network connecting NodeA 10 and its associated logical ports 1000 11 and 1001 12 with NodeB 13 and its associated logical ports 2001 14 and 2002 15. NodeA 10 is a multi-homed node, with six associated IP addresses 16 designated respectively 10.20.30.40, 10.20.40.40, 10.20.50.40, 10.20.60.40, 10.20.70.40, and 10.20.80.40 all connected to IP SwitchA 17. Similarly, NodeB 13 is a multi-homed node, with six associated IP addresses 18 designated respectively 10.30.30.40, 10.30.40.40, 10.30.50.40, 10.30.60.40, 10.30.70.40, and 10.30.80.40 all connected to IP SwitchB 19. The two IP switches 17,19 are connected over the Internet 20 or other network over which data packets are transported using the conventional Internet Protocol (“IP”).

It has been discovered that there is a need to provide a local mechanism for determining whether a particular local process is currently active for the particular combination of source and destination IP addresses and Port numbers (the “Transport Address Pair”) specified in each incoming datagram, and if it does exist, to identify that particular local process as the datagram's logical “Endpoint Association” at the receiving node. A logical “Endpoint Association” as used herein provides a local identity for one or more related streams of information between a local processing node and a remote processing node, and subsumes either a TCP logical “association” or a SCTP logical “connection”.

Thus one embodiment of a logical listing of one set of possible connections active at a given point in time between NodeA and NodeB could include the following ephemeral local Endpoint Associations at NodeA:
[Source IP+Port] [Destination IP+Port]
Endpoint Association 81: [(10-20-50-40)+(1000)] [(10-30-30-40) +(2000)]
Endpoint Association 182: [(10-20-30-40) +(1001)] [(10-30-50-40)+(2001)]+[(10-20-60-40)+(1001)] [(10-30-60-40)+(2001)]
   Note that these endpoint associations are typically listed in numerical order (for example, by means of a linked list in which each active association includes a pointer to the next active association) and typically there will be gaps in the numerical sequence corresponding to connections which have been torn down and the associated number representing that inactive endpoint association has not yet been assigned to another active connection.

Since each Transport Address Pair of a TCP or SCTP connection has two IP addresses and two (service) port numbers, and since exemplary Endpoint Association 182 has two source Transport Addresses and two Destination Transport Addresses, Endpoint Association 182 actually encompasses four available Transport Pairs:
182:1 [(10-20-30-40)+(1001)], [(10-30-50-40)+(2001)]
182:2 [(10-20-30-40)+(1001)], [(10-30-60-40)+(2001)]
182:3 [(10-20-60-40)+(1001)], [(10-30-50-40)+(2001)]
182:4 [(10-20-60-40)+(1001)], [(10-30-60-40)+(2001)].
   One can have an unequal number of transport addresses for the source and destination. In this example they happen to be equal.

It should be noted that in the described embodiments an Endpoint Association number is of local significance only and identifies functionality associated with the local endpoint of the TCP or SCTP connection. The connection between NodeA and NodeB associated with local endpoint association number 81 at Node A is not necessarily represented with the same local association number at Node B. SCTP Datagrams use IP and port numbers to send data across the network, so the receiving node needs to map the IP and port numbers in the datagram back to an appropriate association number that is local to the receiving node. This concept of local association of ephemeral transport addresses specified in the incoming datagrams with a corresponding ephemeral instance of a specific process being performed at (or under the supervision of) the destination node computer is readily extendible to processes performed on other computers and devices connected to that destination node, for example by means of local area networks and private wide area networks, and is especially useful when the destination node is a router or proxy server between a public network and a private network.

A single local SCTP endpoint may be represented as a set of eligible destinations each involving a shared destination port and the multiple eligible IP addresses to which the SCTP packets can be sent in combination with a set eligible sources each involving a shared source port and the multiple eligible IP addresses at which the SCTP packets can be received. Thus, had each combination of one of those eligible destinations with one of those eligible sources is potentially a different Transport Address Pair that potentially defines a different active connection and a different local association with a different local endpoint. In an exemplary known arrangement, all existing associations are organized as a double linked list which is searched sequentially. So a total of 32000 simple associations (only one IP address at each end) requires a list of 32000 Transport Address Pair entries. If 6 nets are supported on each end point, each association will include 12 transport addresses: 6 for local end point and 6 for remote. So to find association 81, then assuming the list is in logical ascending order of association numbers, 80*12 (worst case)+1 entries may have to be examined to find a match. If the message that is received by SCTP module does not include any active transport address pair, it is necessary to traverse the whole list (12*32000 entries) just to determine the message is bogus and should be discarded.

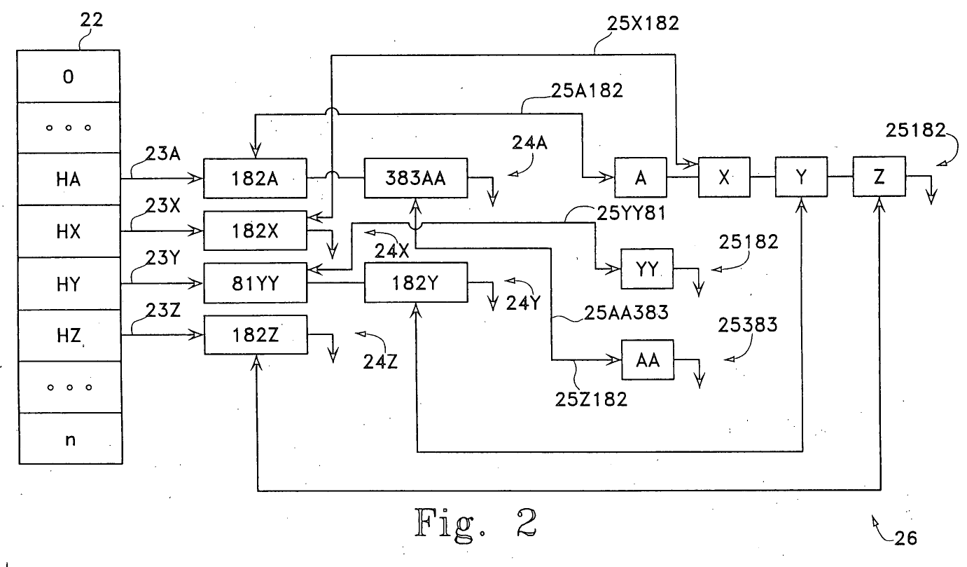

As shown in FIG. 2, one embodiment of the present invention includes a hash key index 22 with entries HA, HX, HY, HZ connected by pointers 23A, 23X, 23Y, 23Z to various linked lists 24A, 24X, 24Y, 24Z of colliding associations 182,81,383. Hashing is a known process for mapping many randomly distributed objects into a limited number of more or less evenly distributed index keys. Thus, each entry of hash array table 22 corresponds to one or more possible transport address pairs that would be mapped into that entry and includes a Linked list of possible associations corresponding to that entry. If the Linked list in question (for example list 24A with Associations 182 and 383) includes more than one possible association (that is to say, the same hash key is derived from both associations), then there is what may be termed a “collision” between those two associations and the linked list may be termed a collision linked list. In the depicted example, association 81's single transport address pair YY generates a hash index of HY; the four possible transport address pairs A, X, Y, Z of association 182 generate respective hash array indexes of HX, HY, HZ, and HA; and the single transport address AA of Association 383 generates the same hash array index of HA as the first transport pair A of Association 182. Note that the four different transport address pairs A, X, Y, Z of association 182 are distributed across 4 different second stage collision linked lists 24A, 24X, 24Y, 24Z. Accordingly, hash index 22 cooperates with the individual linked association lists 24A, 24X, 24Y, 24 Z to form a transport address index.

The FIG. 2 embodiment also includes another set of linked lists of active transport pair addresses, one for each active association, with the individual entries in the transport address list for a particular active association defining the different possible transport addresses. In particular, associations 182, 81, 383 are in turn linked by a second set of pointers 25A182, 25A383, 25X182, 25Y81, 25Y182, 25Z182 to specific transport address pairs A, AA, X, Y, YY, Z in the particular one of the linked lists 2581, 25182, 25383 that functions as the entry for that association in association array 26. Also note that in this embodiment the pointers 25A182, 25A383, 25X182, 25Y81, 25Y182, 25Z182 from the association lists to the transport address lists are preferably bidirectional, and connect a particular instance of the association to a particular transport pair. In particular, pointer 25Y182 from the third instance of association 182 in colliding association linked list 24Y (corresponding to hash key HY) points directly to transport address pair Y in Association double linked list 25182, thereby eliminating any need for an exhaustive search of a potentially lengthy list of active transport addresses that are currently associated with a particular endpoint. Accordingly, the previously described transport address index formed by hash index and the individual linked association lists 24A, 24X, 24Y, 24 Z cooperate to identify all the active associations (endpoints) 24A, 24X, 24Y, 24Z that are associated with a given transport address pair A, AA, X, Y, YY, Z. These same bi-directional pointers 2581, 25182, 25383 links may also be used in the reverse direction during the tear down of the involved connection, for updating the pointers and entries in the affected tables and lists, while each linked transport address list 2581, 25182,25383 that functions as a single association entry within the association array 26 facilitates alternative routing over an already associated different transport address pair for an outgoing datagram that timed out without reaching its intended destination.

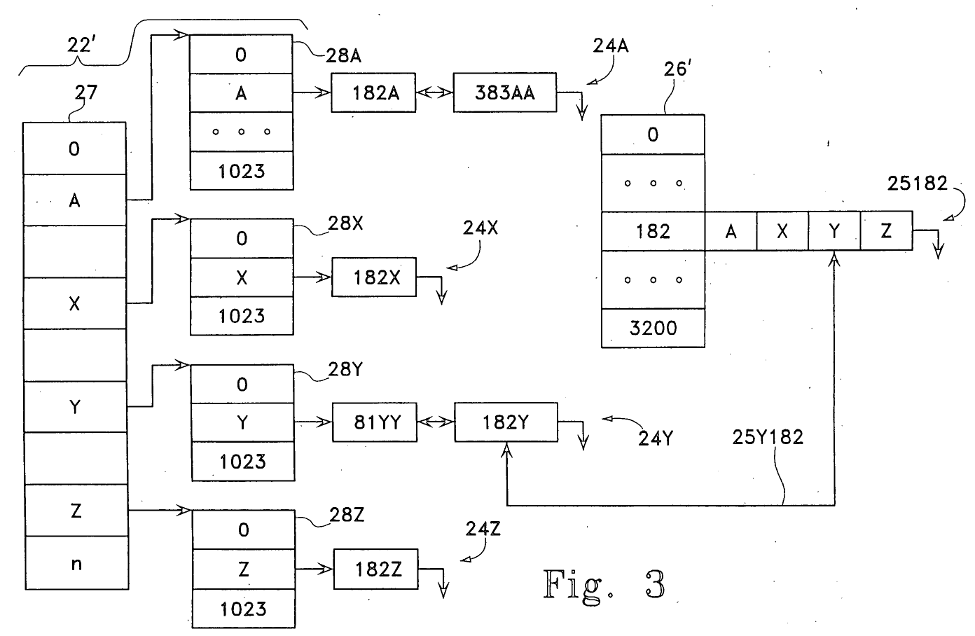

As shown in FIG. 3, in an alternate embodiment the simple single stage hash table 22 of the FIG. 2 embodiment is replaced with a two-dimensional hash table 22′ comprising a first stage 27 and a respective second stage hash table 28A, 28X, 28Y, 28Z for each valid entry in the first stage (or at least those entries that correspond to a “key” collision in the first stage). The same hash key may be used as the index into both stages, suitably divided into “major” and “minor” indices (for example, with the most significant bits serving as the major key and the least significant bits serving as the minor key. Such a two dimensional index organization facilitates memory allocation into smaller blocks and permits currently unused memory blocks to be made available for other processes. Each second stage 28A, 28X, 28Y, 28Z has one or more linked lists 24A′, 24X′, 24Y′, 24Z′ of colliding associations 182,81,383 that are functionally similar to the corresponding colliding association linked lists 24A, 24X, 24Y, 24Z of FIG. 2, and accordingly will not be further explained. Similarly, the Association array 26′ of FIG. 3 corresponds in function to association array 26 of individual linked lists 2581, 25182, 25383 of FIG. 2, except that array 26′ is implemented as a table in which each association (e.g., association 182, comprising transport address pairs A, X, Y, Z) is separately indexed. Note the FIG. 3 embodiment still includes bi-directional pointers from each individual association in the colliding association lists directly to the respective transport address pair in the corresponding association entry (in the interest of clarity, only pointer 25Y182 between colliding association 182Y and transport address pair Y is shown).

Other variations to these particular embodiments of index schemes will doubtless be apparent to those skilled in the art, for example by using simpler or more complex index keys, by using more than one type of index key, and/or by adding additional stages of index tables, decision trees, and/or linear lists. As another example, only the local endpoint or transport address can be used in the first stage with the second stage being in the form of a balanced binary tree of remote transport addresses. In any event, it is advantageous that there be a relatively short and straightforward path from colliding (or ambiguous) possible associations to the particular active transport addresses responsible for that ambiguity, and that there be not only an efficient mechanism for determining the association from the transport address, but also that there be a comparable mechanism for determining any available alternative transport addresses from the original transport address, so that all other Transport address pairs for that association can be found easily for packet round-robins, retries, setup, and teardown procedures.

Those skilled in the computer software arts art will be familiar with hash indexed tables and double linked lists and should have no difficulty in implementing the basic operations that need to be supported during setup and teardown of an SCTP connection such as Insert, Search and Delete. Similarly, those skilled in the art will be familiar with conventional techniques of allocating and deallocating the memory required for the various tables and lists, either using a static allocation based on the maximum supported capacity, or a dynamic allocation that is dependent on the number and complexity of the active connections.

An exemplary code snippet for such a two stage hash index is given below, in which the hash of local and remote transport (IP address+port) addresses is calculated and referred to as KEY. Key then is divided by 1024 or shifted 10 bits to get most significant bits of the key and that number is used as the Major Hash Key.

```
/* Allocate Hash Table memory and initialize a bit */
  for (i=0;i<32;i++)
    {
    HashList[i] = (LinkedList *) malloc (sizeof(LinkedList) * 1024);
    if (HashList[i] == NULL)
      {
        printf (“HashList[%d] malloc failed\n”, i);
        exit (−1);
      }
    CurrentList = HashList[i];
    for (j=0;j<1024;j++)
      {
      CurrentList->Valid = FREE; /* Not a Valid Entry yet */
      CurrentList->next = NULL;
      CurrentList->prev = NULL;
      CurrentList += 1;
        }
      }
typedef struct_Linked_List
{
  u_long Key; /* XOR of LocalIP + LocalPort + Remote Ip +
  RemotePort
    */
  int Valid; /* Valid entry or not a valid entry */
  u_long LocalIpAddr;
  u_short LocalPortNumber;
  u_long RemoteIpAddr;
  u_short RemotePortNumber;
  int Assoc;
  void *next;
  void *prev;
}
```

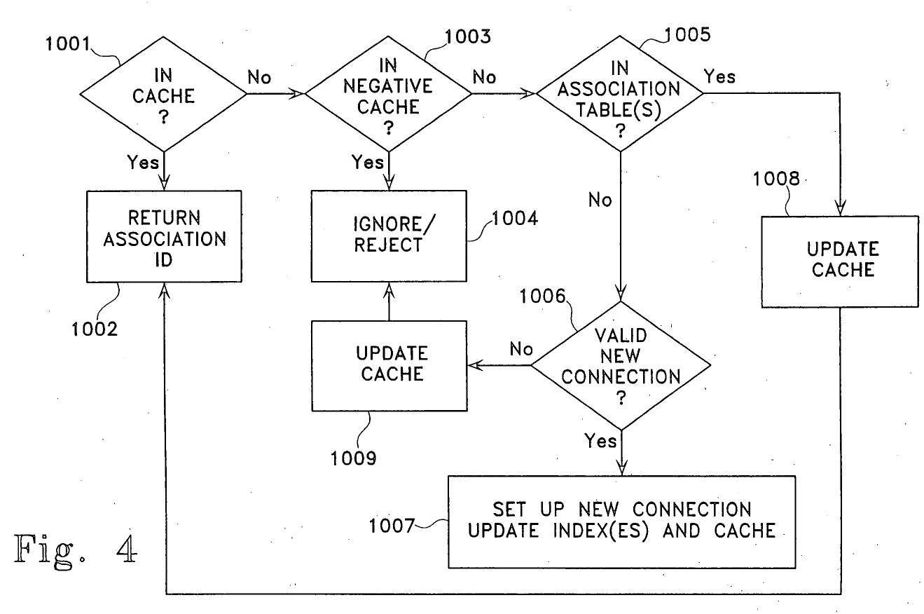

FIG. 4 illustrates an embodiment of a possible look-aside and caching scheme based on an assumption that in a recent time window, most of the received messages originate from a relatively small number of distinct transport addresses.

In block 1001, the transport address pair is used to locate a corresponding active association ID (Local endpoint) in a positive cache of selected active connections. If there is a match, the corresponding association ID (for example, association 182) is returned (block 1002). Those skilled in the computer programming and computer architecture arts will be familiar with various approaches to constructing and operating such a cache, and the possible tradeoffs between the size of the cache and the resulting costs and benefits.

Preferably, there is also a negative cache search (block 1003) for recently disconnected or disallowed transport addresses. Just removed service will have an entry in this table, so that the packets coming afterwards can be quickly thrown away (block 1004). Although the figure shows the two caches as logically separate and the two operations sequential, the negative cache can simply be implemented as part of the regular cache, with the association ID field being replaced with a code that indicates the status of that particular transport address.

Possible policies that can be used with such a cache include:
Do not empty “critical” cache entries (for example cluster or security or monitoring or low latency requirement for specific apps); and
Specified time window for retaining certain types of entries (based on last time used, time tear-down occurred, etc.) and time window based entries.

If the transport address pair in question is not found in either cache, it is then used to generate an index key to access the previously described data structure (block 1005) which contains all active associations and all active transport address pairs, and if still not found, is then examined (block 1006) for possible acceptance as a new connection (block 1007) or for possible rejection (block 1004) as a bogus or illegal connection attempt. In any event, the transport address may be added to the cache (blocks 1007, 1008, 1009) in accordance with the cache policies then in effect.

In a multiprocessor or multi-node or cluster processing environment, these various data-structures and processes may be readily distributed and/or multiple copies may be maintained. Doubtless, other modifications and enhancements will be apparent to those skilled in the art. For example, different association processes can be invoked depending on the state of node, or that are specific to a particular port or IP address. Moreover, many of the described novel features may be applicable not only to the SCTP transport layer of a conventional TCP/IP stack, but to other transport protocols such as TCP, UDP, IP, ICMP.

1. A method for determining an endpoint association between a transport address pair in a received datagram and an endpoint for the received datagram, at least some of the endpoints involving more than one transport address pair, the method comprising:
setting up an endpoint association array including for each active endpoint in the array a list of all the transport addresses involved with that endpoint;
setting up a transport address index for active transport address pairs including, for each separately indexed unit of transport addresses, individual pointers to all the potentially matching transport addresses in the endpoint array; and
using the transport address pair of the received datagram and the transport address index to locate an active endpoint association in the endpoint array that is associated with a matching transport address pair.

2. The method of claim 1 wherein the endpoints are local endpoints.

3. The method of claim 1 wherein the transport addresses are each in the form of a transmit address pair.

4. The method of claim 3 wherein at least some of the received datagrams are SCTP datagrams being received over the Internet, at least some of the transport address pairs include source and destination IP addresses and source and destination port numbers, and at least some of the endpoints are defined by SCTP associations.

5. The method of claim 3 wherein at least some of the received datagrams are TCP datagrams being received over the Internet, at least some of the transport address pairs include source and destination IP addresses and source and destination port numbers, and at least some of the endpoints are defined by TCP connections.

6. The method of claim 1 further comprising when setting up a new endpoint association:
inserting a new transport address list into the endpoint association array; and
inserting one or more new transport address pointers into all corresponding units of the transport address index.

7. The method of claim 1 further comprising when tearing down an old connection involving an identified transport address pair associated with an active endpoint association:
using the transport address index to locate the transport address list for that active endpoint association;
using the located transport address list to locate all other transport addresses involved with that same active endpoint association;
removing the pointers to the identified transport address pair and to any other transport addresses involved with that active endpoint association from the transport address index; and then
removing the active endpoint and its associated transport address list from the endpoint association array.

8. The method of claim 1 wherein each said transport address is a transport address pair including a transmit node address, a receive node address, a transmit port address, and a receive port address.

9. The method of claim 1 wherein the transport address index includes a hash table, each separately indexed unit includes all the active transport addresses that are mapped to a single entry in the hash table, and at least one entry of the hash table has an associated collision list including more than one potentially matching transport address that is so mapped.

10. The method of claim 9 wherein the hash table is a two stage hash table, the second stage functions as respective collision lists for the first stage, and at least some entries in the first stage do not have any associated second stage collision list entries.

11. The method of claim 10 wherein the second stage is a single shared table.

12. The method of claim 10 wherein the second stage includes a separate table for each entry in the first stage having more than one potentially matching transport address.

13. The method of claim 1 further comprising the steps:
establishing a cache of recently encountered transport addresses; and
using the transport address index and the endpoint array to locate a matching endpoint only when the transport address of the incoming datagram is not in the cache.

14. The method of claim 13 wherein the cache includes at least some invalid transport addresses not linked to any active endpoint association.

15. The method of claim 13 wherein the cache includes at least some valid transport addresses linked to one or more active endpoint associations.

16. Machine-readable media containing a stored program for determining an association between a transport address pair in a received datagram and an endpoint for the received datagram, at least some of the endpoints including more than one such transport address pair, the stored program comprising:
a procedure for setting up an endpoint array including for each active endpoint in the array a list of all the transport addresses involved with that endpoint;
a procedure for setting up a transport address index for active transport address pairs including for each separately indexed unit of transport addresses individual pointers to all the potentially matching transport addresses in the endpoint array; and
a procedure for using the transport address pair of the received datagram and the transport address index to locate an active endpoint in the endpoint array that includes a matching transport address pair.

17. The media of claim 16 wherein the stored program further comprises a procedure for inserting a new transport address list into the endpoint array and for inserting one or more new connection transport address pointers into all corresponding units of the transport address index.

18. The media of claim 16 wherein the stored program further comprises
a procedure for using the transport address index to locate a transport address list for a specified endpoint and for using the located transport address list to locate all other transport addresses involved with that same active endpoint; and
a procedure for removing the pointers to the identified transport address pair and to any other transport addresses involved with that active endpoint from the transport address index and for removing the active endpoint and its associated transport address list from the endpoint array.

19. The media of claim 16 wherein at least some of the received datagrams are SCTP datagrams being received over the Internet, at least some of the transport node addresses are IP addresses, and at least some of the endpoints are SCTP endpoints.

20. The media of claim 16 wherein the transport address index includes a hash table, each separately indexed unit includes all the active transport addresses that are mapped to a single entry in the hash table, and at least one entry of the hash table has an associated collision list including more than one potentially matching transport address that is so mapped.

21. The media of claim 20 wherein the hash table is a two stage hash table, the second stage functions as respective collision lists for the first stage, and at least some entries in the first stage do not have any associated second stage collision list entries.

22. The media of claim 16 wherein the stored program further comprises:
a procedure for establishing a cache of recently encountered transmission addresses and for using the transport address index and the endpoint array to locate a matching endpoint only when the transport address of the incoming datagram is not in the cache.

23. A communication node capable of determining an association between a transport address pair in a received datagram and an endpoint for the received datagram, at least some of the endpoints including more than one such transport address pair, the communication node comprising:
an endpoint association array including for each active endpoint association in the array a list of all the transport addresses involved with that endpoint association;
a transport address index for active transport address pairs including for each separately indexed unit of transport addresses individual pointers to all the potentially matching transport addresses in the endpoint association array; and
an automated process for using the transport address pair of the received datagram and the transport address index to locate an active endpoint association in the endpoint association array that includes a matching transport address pair.

24. The node of claim 23 wherein the automated process further comprises means for inserting a new transport address list into the endpoint association array and for inserting one or more new connection transport address pointers into all corresponding units of the transport address index.

25. The node of claim 23 wherein the automated process comprises:
a procedure for using the transport address index to locate a transport address list for a specified endpoint association and for using the located transport address list to locate all other transport addresses involved with that same active endpoint association; and
a procedure for removing the pointers to the identified transport address pair and to any other transport addresses involved with that active endpoint association from the transport address index and for removing the active endpoint association and its associated transport address list from the endpoint association array.

26. The node of claim 23 wherein at least some of the received datagrams are SCTP datagrams being received over the Internet, at least some of the transport node addresses are IP addresses, and at least some of the endpoints are SCTP endpoints.

27. The node of claim 23 wherein the transport address index includes a hash table, each separately indexed unit includes all the active transport addresses that are mapped to a single entry in the hash table, and at least one entry of the hash table has an associated collision list including more than one potentially matching transport address that is so mapped.

28. The node of claim 23 wherein the hash table is a two stage hash table, the second stage functions as respective collision lists for the first stage, and at least some entries in the first stage do not have any associated second stage collision list entries.

29. The node of claim 23 wherein the automated process further comprises:
a procedure for establishing a cache of recently encountered transmission addresses and for using the transport address index and the endpoint array to locate a matching endpoint only when the transport address of the incoming datagram is not in the cache.
